(19) United States
(12) Patent Application Publication
(10) Pub. No.: US 2003/0024583 A1
(43) Pub. Date: Feb. 6, 2003

(54) Mixing insert for a chemical injector

(76) Inventor: Gary A. Baker, Gold Hill, OR (US)

Correspondence Address: MARGER JOHNSON & McCOLLOM, P.C., 1030 S.W. Morrison Street, Portland, OR, 97205, US

(21) Appl. No.: 10/253,225

(22) Filed: Sep. 23, 2002

Related U.S. Application Data
(63) Continuation-in-part of application No. 09/832,432, filed on Apr. 10, 2001, now Pat. No. 6,453,926.

(51) Int. Cl. F16K 1/00

(52) U.S. Cl. 137/890

(57) ABSTRACT

An insert for use in a chemical injector adapted to be interposed within the path of the fluid stream flowing from an upstream conduit to a downstream conduit. The insert has a body that includes a primary flow channel substantially parallel to the fluid flow. A chemical reservoir is formed on an outer surface of the tubular body and intermediate the upstream end and the downstream end of the body, with a chemical feed channel substantially parallel with the longitudinal axis and communicating with both of the reservoir and the downstream face. In an alternative embodiment, a chemical staging recession is structured on an outer aspect of the body. The staging recession forms a reservoir for fluid chemical when the insert is positioned within a chemical injector.

### CROSS REFERENCE TO RELATED APPLICATION

This application is a continuation-in-part of and claims priority from U.S. Ser. No. 09/832,432, filed on Apr. 10, 2001.

### BACKGROUND OF THE INVENTION

The present invention is related to a chemical injector, and more specifically to an insert for use in a system for inducing chemical treatment of a fluid stream, such as dechlorination of water, and introduction of the chemical into a fluid stream without diverting the direction of flow of the fluid stream itself.

A chemical injector system can be used in a broad variety of applications encompassing a range of fluid flow pressures and chemical viscosities. As well, it may be advantageous for an injected chemical to mix relatively rapidly with the flowing fluid. Mechanical mixing devices are available, creating turbulence by utilizing moving parts or hydrodynamic vanes. Such devices add a level of complexity and have increased manufacturing and maintenance costs.

In applications wherein a selected amount of chemical is to be introduced into a particular volume of fluid, a system may be employed which introduces chemical at a steady rate, irrespective of fluctuations in fluid stream flow rate. This chemical introduction scheme is effective because importance is placed on the final concentration of chemical in the fluid. Where aliquots are to be taken from the stream during chemical introduction, it becomes critical that the chemical concentration remain constant at any point in the fluid stream. An example of such applications include, e.g., liquid-state pharmaceutical manufacturing wherein chemical is injected into a fluid stream and the mixture portioned flow-wise for further processing or packaging.

Similarly, in agricultural pesticide injection into irrigation fluid flowed to a crop site for application thereto, it is desirable that a particular concentration of pesticide be applied per volume of irrigation water. As well, constant chemical introduction rate systems are inadequate when it is desired that the chemical injection rate be dynamically adjustable (e.g., dechlorination of water, wherein chlorination decreases during the dechlorination process and the rate of neutralizing chemical injection must be correspondingly reduced).

The invention will become more readily apparent from the following Detailed Description, which proceeds with reference to the drawings, in which:

### BRIEF DESCRIPTION OF THE DRAWINGS

FIGS. 1-3 are side, end and longitudinal cross-sectional views, respectively, of a first embodiment mixing insert.

FIGS. 4-6 are side, end and longitudinal cross-sectional views, respectively, of a second embodiment mixing insert.

FIG. 7 is a cross-sectional diagram showing the insert of FIGS. 1-3 positioned within a chemical injector system.

FIG. 8 is a cross-sectional diagram showing the insert of FIGS. 4-6 positioned within the chemical injector system.

### DETAILED DESCRIPTION OF PREFERRED EMBODIMENT(S)

The present invention provides a way to introduce a chemical into a fluid stream, injecting and intermixing said chemical with the fluid stream. As used herein, the term “fluid” is meant to refer to a substance that is flowed or capable of flowing, without limitation as to the state of the substance being so flowed. In other words, where a stream of oxygen can be passed through the apparatus, the oxygen flow would be referred to herein as a fluid stream of oxygen.

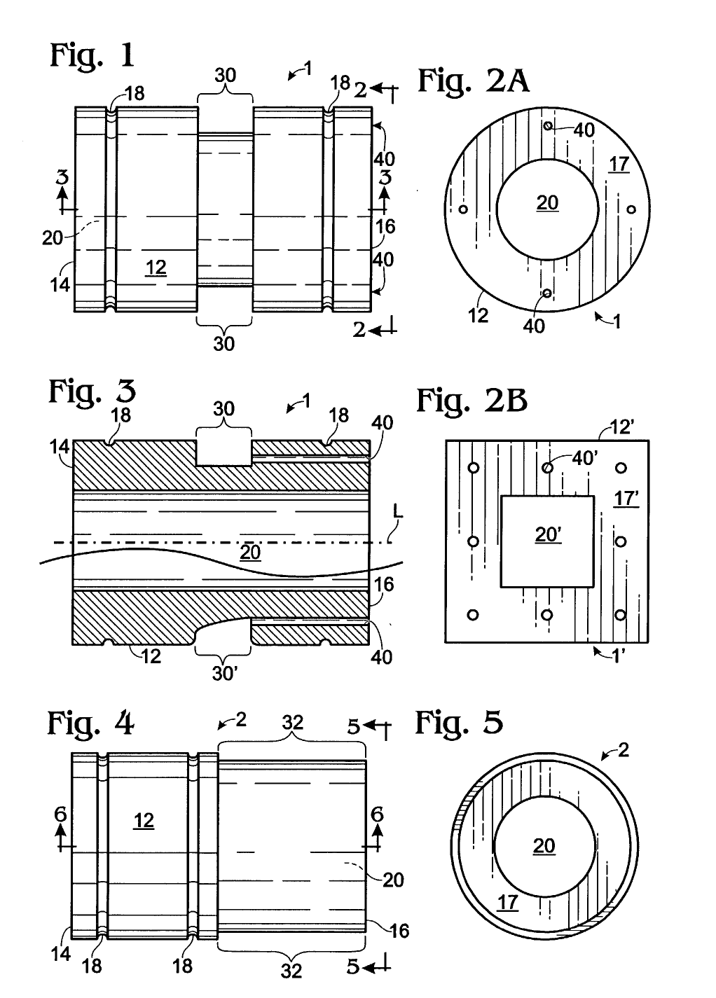

Turning now to FIGS. 1-3, one embodiment of the insert 1 according to the present disclosure is shown in respective side, downstream face and sagittal views. The insert 1 comprises a tubular body 12 having two ends. The upstream end 14 ends in an upstream face (not visible), and a downstream end 16 similarly ends in a downstream face 17.

The insert 1 further includes a primary flow channel 20 positioned parallel to the longitudinal axis L of the insert. In the illustrated embodiment, the primary channel 20 is axially positioned within the tubular body 12, although the primary flow channel 20 can efficaciously be non-concentrically located.

A chemical reservoir 30 is formed on an outer surface of the tubular body 12. in the embodiment of FIGS. 1-3, the reservoir 30 resides intermediate the upstream end 14 and the downstream end 16.

In this embodiment, four chemical feed channels 40 are structured substantially parallel with the longitudinal axis L. The chemical feed channels 40 communicate with both of the reservoir 30 and the downstream face 16.

As the insert 1 is adapted to be inserted into a chemical injector system S, one or more grooves 18 may be structured on the outer surface of the insert to accept O-rings or other fluid sealing means.

A first alternative embodiment insert 2 is seen in FIGS. 4-6. This insert 2 also includes a body 12 having an upstream end 14 with an upstream face (not visible), and a downstream end 16 with a downstream face 17. A primary flow channel 20 is aligned with a longitudinal axis L of the body 12.

A chemical staging recession 32 resides on an outer aspect of the body 12 and extends from the downstream end 16 to a point intermediate the downstream end 16 and the upstream end 14.

The above-described inserts are shown herein as right cylindrical tubular bodies. Other shapes can readily be envisioned, such as rectangular (body 1′ as shown in FIG. 2B), oval, or polygonal. Such profiles would be dictated by the shape of the chemical injector system for which the insert is intended to be compatible.

Similarly, the outer profile of an insert need not be constant, but can vary as desired to fit within a particular chemical injector apparatus. For example, an insert can be constructed having a silhouette that is conical.

The chemical reservoir 30 and the chemical staging recession 32 are shown herein as an annular groove extending around the circumference of the insert 1 and insert 2, respectively. Other embodiments can be contemplated wherein, for example, the reservoir 30 or recession 32 can be an annular groove extending only partway around the insert circumference.

Similarly, the reservoir/recession may be shaped as a groove or indentation coursing longitudinally along the insert, or simply may be a depression in the body 12, communicating directly with the chemical feed port 40.

Likewise, the chemical reservoir 30 can have contours other than the right-angled annular groove depicted in FIGS. 1-6. In an alternative embodiment, the body 12 can have an hourglass shape wherein the circumference of a central portion is less than the circumference of the ends of the body. The chemical reservoir 30 would then be the decreased central circumference of such a construct.

An insert as herein described is adapted for use in a chemical injector system S. The injector system S is expected to include an appropriately-sized receiving cavity into which an insert can be positioned. The injector system will further include a chemical feed port for connection to a source of the chemical to be injected.

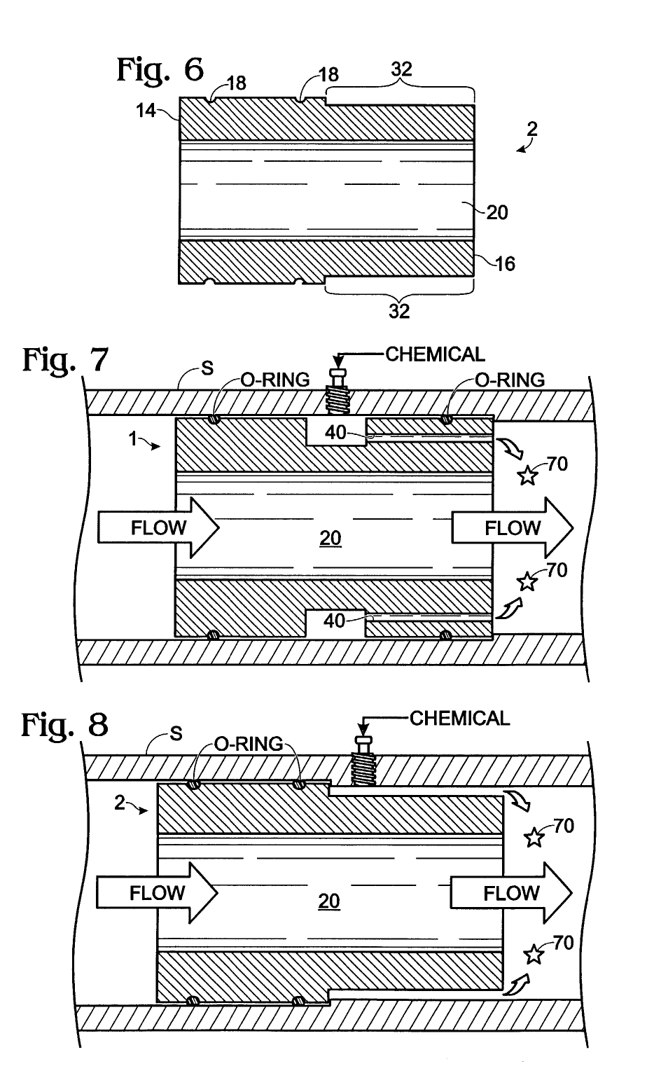

As shown in FIG. 7, the insert 1 described herein is intended to be positioned within a chemical injection system S and thereby interposed within a fluid stream FLOW such that fluid flowing through the system is flowed through the primary flow channel 20 of the insert 1.

Positioning of an insert within a chemical injector system can be accomplished via positioning means, such as O-rings accepted into one or more grooves 18 on the body.

O-rings can also serve a fluid sealing function, contacting an interior wall of the injector housing to prevent chemical within reservoir 30 from escaping into a space between the interior wall of the injector housing and the outer portion of the insert 1.

Fluid emerging from the primary channel 20 exerts a back-pressure (stars 70) on the secondary channel 22 at its opening on the downstream face 17 of the insert 1. Such back-pressure 70 draws chemical (cross-hatched arrow) through the chemical feed channel 40 from the chemical reservoir 30 and into the fluid stream flowing through the insert 1.

FIG. 8 similarly shows insert 2 positioned within the injector system. Fluid emerging from the primary channel 20 exerts a back-pressure 70, urging chemical in the chemical staging recession 32 into the fluid stream. In contrast to the chemical feed channel(s) 40 of insert 1, the path of chemical flow for insert 2 is directly from the chemical staging recession 32 into the fluid stream.

The insert of the present invention can be used to introduce a chemical into a fluid stream. As discussed in the example of water dechlorination, the fluid stream and chemical are both in an freely flowing liquid state. Alternatively, either the fluid stream or the chemical can be viscous, exemplary of pharmaceutical applications.

In yet other embodiments, a gaseous stream can be passed through the apparatus and chemical injected into such stream. Similarly, the chemical also can be in a gaseous state. Introduction of gaseous chemical, including air, can be performed to aerate liquid, for example in a water body in which aquatic flora or fauna are to be sustained.

It should be apparent that, where the maximum chemical flow rate is limited by the size of the channels through which chemical must travel, such maximum can be manipulated by construction of an embodiment with a differently sized chemical reservoir 30, chemical feed channel 40 or primary channel 20. It is anticipated that modification of the chemical feed channel 40 has the greatest effect on chemical flow rate through the apparatus described herein.

In the embodiment 2 of FIGS. 4-6, the dimensions of the staging recession also can be varied to affect the introduction rate of chemical into the fluid stream. This insert 2 is anticipated to more efficaciously inject a viscous chemical into a fluid stream, because the insert 2 does not require chemical to flow through a narrow chemical feed channel 40. The embodiment of FIGS. 4-6 nevertheless can be successfully employed for injection of less viscous chemicals.

A person skilled in the art will be able to practice the present invention in view of the description present in this document, which is to be taken as a whole. Numerous details have been set forth in order to provide a more thorough understanding of the invention. In other instances, well-known features have not been described in detail in order not to obscure unnecessarily the invention.

While the invention has been disclosed in its preferred form, the specific embodiments thereof as disclosed and illustrated herein are not to be considered in a limiting sense. Indeed, it should be readily apparent to those skilled in the art in view of the present description that the invention can be modified in numerous ways. The inventor regards the subject matter of the invention to include all combinations and subcombinations of the various elements, features, functions and/or properties disclosed herein.

The invention claimed is:

1. An insert adapted for use in a chemical injection system, the insert comprising:
a body including:
an upstream end having an upstream face, and
a downstream end having a downstream face;
a primary flow channel aligned with a longitudinal axis of the body;
a chemical reservoir formed on an outer surface of the body and intermediate the upstream end and the downstream end thereof;
a chemical feed channel substantially parallel with the longitudinal axis and communicating with both of the reservoir and the downstream face.

2. The insert of claim 1 wherein the tubular body is circular in cross-section.

3. The insert of claim 1 wherein the tubular body is oval in cross-section.

4. The insert of claim 1 wherein the tubular body is rectangular in cross-section.

5. The insert of claim 1 wherein the primary flow channel is cylindrical.

7. The insert of claim 1, further comprising a plurality of chemical feed channels substantially parallel with the longitudinal axis and communicating with both of the reservoir and the downstream face.

8. An insert for introducing a chemical into a stream, the insert comprising:
a body including:
an upstream end with an upstream face, and
a downstream end with a downstream face;
a primary flow channel aligned with a longitudinal axis of the body; and
a chemical staging recession on an outer aspect of the body.

9. The insert of claim 8 wherein the body is circular in cross-section.

10. The insert of claim 8 wherein the body is rectangular in cross-section.

11. The insert of claim 8 wherein the primary flow channel is cylindrical.

12. The insert of claim 8 wherein the body has a larger cross-sectional dimension at either of the upstream end and the downstream end than the cross-sectional dimension at the other end of the body.

13. The insert of claim 8 wherein the primary flow channel is coaxially aligned with a longitudinal axis of the body.

14. The insert of claim 8 wherein the chemical staging recession extends from the downstream end of the body to a point intermediate the upstream end of the body.

15. The insert of claim 8 wherein the chemical staging recession is circumferentially positioned on the body.

16. The insert of claim 8 wherein a length of the chemical staging recession is less than a circumference of the body.

17. The insert of claim 8 wherein a reservoir cavity is formed when the insert is positioned in a chemical injector.

18. The insert of claim 17 wherein the reservoir cavity is defined by the chemical staging recession and the chemical injector when the insert is positioned within the chemical injector.

19. An insert adapted for use in a chemical injector apparatus, the insert comprising:
a body including an upstream end having an upstream face, and a downstream end having a downstream face;
a primary flow channel aligned with a longitudinal axis of the body; and
a chemical reservoir formed on an outer surface of the tubular body.

20. The insert of claim 19 wherein a cross-sectional shape of the body is one of circular, rectangular and cylindrical.

21. The insert of claim 19 wherein the chemical flow channel is coaxially aligned with the longitudinal axis of the body.

22. The insert of claim 19 wherein the chemical staging recession extends from the downstream end of the body to a point intermediate the upstream end of the body.

23. The insert of claim 19, further comprising a chemical feed channel substantially parallel with the longitudinal axis and communicating with both of the chemical reservoir and the downstream face; and
wherein the chemical reservoir is formed on an outer surface of the body and intermediate the upstream end and the downstream end thereof.

24. The insert of claim 23, further comprising a plurality of chemical feed channels substantially parallel with the longitudinal axis and communicating with both of the reservoir and the downstream face.
